(19) United States
(12) Patent Application Publication
(10) Pub. No.: US 2024/0103872 A1
(43) Pub. Date: Mar. 28, 2024

(54) TRUNCATION FLOATING-POINT CONVERSION TO INTEGER WITH SATURATION

(71) Applicants: John MORGAN, Snoqualmie, WA (US); Deepti AGGARWAL, Gilbert, AZ (US); Michael ESPIG, Newberg, OR (US)

(72) Inventors: John MORGAN, Snoqualmie, WA (US); Deepti AGGARWAL, Gilbert, AZ (US); Michael ESPIG, Newberg, OR (US)

(21) Appl. No.: 18/192,500

(22) Filed: Mar. 29, 2023

Related U.S. Application Data
(60) Provisional application No. 63/410,142, filed on Sep. 26, 2022.

(51) Int. Cl. G06F 9/30

(52) U.S. Cl. CPC G06F 9/3016; G06F 9/30014; G06F 9/30036

(57) ABSTRACT

Techniques for performing floating-point to integer conversion with saturation are described. In some examples, an instruction is executed to perform the conversion. In some examples, a single instruction to include at least one or more fields for an opcode and one or more fields for location information for at least a first source operand and a destination operand, wherein the opcode is to indicate execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows.

### BACKGROUND

Most floating-point operations signal an invalid operation by returning a value that is Not-a-Number (NaN) but that is not an option for conversions of floating-point values to non-floating-point types, such as integer types. Although standard C and C++ do not specify what value should be returned for an invalid conversion, two conventions are commonly used. The first was established by Intel with the 8087 floating-point coprocessor, which uses the result value farthest from zero as a proxy for a NaN value. Although this sentinel value does not propagate as NaN values do, it can be easily detected and usually causes distinctive behavior in the resulting computation.

Another convention is to return the result value closest to the original floating-point value if it is numeric, and to return zero for NaN values. This has two advantages. First, because the result value is as close to the source value as possible, many algorithms that are influenced by the relationship of values will tend toward the correct result even when the result is wrong. This is particularly true for Machine Learning algorithms, which can often compute the same result with very different matrix types and values. The second advantage is that when a saturated value is subjected to another saturating down-conversion, it remains a saturated value. This means that it is possible to implement a complete set of saturating conversions without needing separate instructions for each one.

Because these conversions and several other language features have undefined behaviors in standard C++, it is difficult to verify correctness or portability of any C++ code that relies on them. In contrast, the Rust language does not allow such undefined behavior. It requires saturating conversions regardless of which platform the code is running on. Similarly, WASM defines an instruction that implements saturating conversion explicitly. The predictability of these languages is making them increasingly popular and may influence other languages to adopt saturating conversion as required behavior.

### BRIEF DESCRIPTION OF DRAWINGS

Various examples in accordance with the present disclosure will be described with reference to the drawings, in which:

FIG. 1 illustrates an example execution of a single instance of a floating-point conversion to integer using truncation or saturation instruction.

FIG. 2 illustrates examples of computing hardware to process a VCVTTxx instruction.

FIG. 3 illustrates an example method to process an instance of a VCVTTxx instruction using circuitry, emulation, and/or binary translation.

FIG. 4 illustrates an example computing system.

FIG. 5 illustrates a block diagram of an example processor and/or System on a Chip (SoC) that may have one or more cores and an integrated memory controller.

FIG. 6(A) is a block diagram illustrating both an example in-order pipeline and an example register renaming, out-of-order issue/execution pipeline according to examples.

FIG. 6(B) is a block diagram illustrating both an example in-order architecture core and an example register renaming, out-of-order issue/execution architecture core to be included in a processor according to examples.

FIG. 7 illustrates examples of execution unit(s) circuitry.

FIG. 8 is a block diagram of a register architecture according to some examples.

FIG. 9 illustrates examples of an instruction format.

FIG. 10 illustrates examples of an addressing information field.

FIG. 11 illustrates examples of a first prefix.

FIGS. 12(A)-(D) illustrate examples of how the R, X, and B fields of the first prefix in FIG. 11 are used.

FIGS. 13(A)-(B) illustrate examples of a second prefix.

FIG. 14 illustrates examples of a third prefix.

FIG. 15 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for performing floating-point conversion to integer with saturation.

A disadvantage of using legacy instruction sequences is that they can be quite slow compared to a native conversion instruction, especially when correct exceptions must be generated. They also add many instructions for a relatively simple operation and can be difficult to recognize or understand when debugging at the instruction level.

Detailed herein are examples of conversion instructions and their support that are similar in format to legacy conversion instructions and combine features of both the truncating and non-truncating conversions so that half as many instructions are needed to implement a full set of conversions. The source value may be in a vector register or memory. The destination for a scalar conversion is a general purpose register (GPR) and for vector conversions it is a vector register. Like truncating legacy conversions, the default rounding mode is truncation, and like non-truncating conversions the rounding mode can be overridden using embedded rounding. In the unlikely event it is necessary to round according to the FP control register rounding mode, a ROUNDxx instruction can be used to do that since truncating a rounded value results in no change.

These instructions have some advantages over other conversion instructions. Some architectures require operands to be loaded into registers, however some architectures have two sets of vector instructions (two vector ISAs) and registers and implement different conversion in both ISAs. None allow masking, the selection of the rounding mode, embedded broadcast or suppression of exceptions.

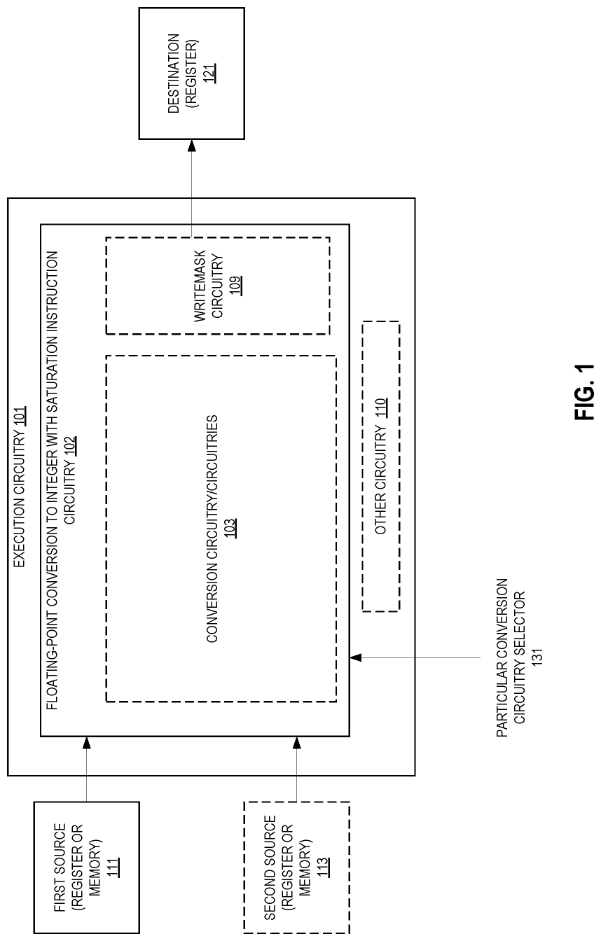

FIG. 1 illustrates an example execution of a single instance of a floating-point conversion to integer using truncation or saturation instruction. While this illustration is in little endian format, the principles discussed herein work in big endian format. In some examples, the floating-point conversion to integer using truncation or saturation instruction is one of: VCVTTPD2QQS (convert with truncation packed double-precision floating-point values to packed quadword integers with saturation), VCVTTPD2UDQS (convert with truncation packed double-precision floating-point values to packed unsigned doubleword integers with saturation), VCVTTPD2UQQS (convert with truncation packed double-precision floating-point values to packed unsigned quadword integers with saturation), VCVTTPD2QQS (convert with truncation packed double-precision floating-point values to packed quadword integers with saturation), VCVTTPD2UDQS (convert with truncation packed double-precision floating-point values to packed unsigned doubleword integers with saturation), VCVTTPS2QQS (convert with truncation packed single-precision floating-point values to packed signed quadword integers with saturation), VCVTTPS2UQQS (convert with truncation packed single-precision floating-point values to packed unsigned quadword integers with saturation), VCVTTSD2USIS (convert with truncation packed scalar double-precision floating-point value to packed unsigned integer with saturation), and/or VCVTTSD2USIS (convert with truncation packed scalar single-precision floating-point value to packed unsigned integer with saturation).

The execution of each of the instruction converts with truncation or saturation, packed floating-point values in the source operand(s) to an integer values (singed or unsigned) to be stored in the destination. In some examples, when a conversion is inexact, a truncated (round toward zero) value is returned. In some examples, if the integer overflows the result is saturated (e.g., to the highest positive or negative value that can be represented). In some examples, if a converted result cannot be represented in the destination format, the floating-point invalid exception is raised, and if this exception is masked, the indefinite integer value (2^{w}−1, where w represents the number of bits in the destination format) is returned.

As shown, in response to a decoded a floating-point conversion to integer instruction, execution circuitry 101 converts floating-point values (from a first source 111 and, in some examples, from a second source 113) into integers using truncation or saturation using conversion circuitry/circuitries 103 of floating-point conversion to integer with saturation instruction circuitry 102 and writes the integers into destination register 121. In some examples, the writemask circuitry 109 is used to selectively write to the destination register 121 (which, in some examples, is one of the sources).

In some examples, the conversion operation that is to be performed by circuitry in response to a single instruction is, at a high-level, as follows:

```
If embedded rounding is selected,
  Set invalid_signling to false
  Set rounding_mode to selected rounding mode
Otherwise
  Set invalid_signaling to not MXSCR.IM
  Set rounding_mode to truncation
If the source value is Not-a-Number,
  Set result to zero
  If invalid_signaling,
    Signal invalid
Otherwise,
  Set rounded_source = round(source, rounding_mode)
  If rounded_source is greater than maximum_possible_result
    If invalid_signaling,
      Signal invalid
    Set result to maximum_possible_result
Otherwise,
  If rounded_source is less than minimum_possible_result
    Set result to minimum_possible_result
    If invalid_signaling,
      Signal invalid
Otherwise
// perform conversion as required by the specific FP datatype and size
  Set result to rounded_source converted to the result type
```

More concrete examples of operations of convert with truncation packed double-precision FP values to packed quadword integers using truncation or saturation instruction using circuitry are as follows:

```
Operation
VCVTTPD2QQS (EVEX encoded version) when src operand is a register
//EVEX = THE THIRD PREFIX
IF (EVEX.b == 1)
  THEN
    (KL, VL) = (8, 512);
  // ROUNDING MODES MAY BE ONE OF: NEAREST, TOWARD NEGATIVE INFINITY,
  //TOWARD POSITIVE INFINITY, TOWARD ZERO
  // EVEX.RC IS SET BY BITS 20-22 or BITS 21-22 of 901(C)
    SET_ROUNDING_MODE_FOR_THIS_INSTRUCTION(EVEX.RC)
  ELSE
    (KL, VL) = (2, 128), (4, 256), (8, 512);
    SET_ROUNDING_MODE_FOR_THIS_INSTRUCTION(TRUNCATE)
FI;
FOR j := 0 TO KL-1
  i := j * 64;
  IF k1[j] OR *no writemask*
    THEN
      TEMP := Round(SRC[i+63:i]);
      IF Is_Not_a_Number(TEMP)
        THEN
          RESULT := 0
        ELSE
        // SATURATION
          IF TEMP > 9,223,372,036,854,775,807
            THEN
              RESULT = 9,223,372,036,854,775,807
            ELSE
              IF TEMP < −9,223,372,036,854,775,808
                THEN
                  RESULT = −9,223,372,036,854,775,808
                ELSE
                  RESULT :=
                Convert_Double_Precision_Floating_Point_To_QuadInteger(TEM
                P)
              FI
          Fi
      FI;
      DEST[i+63:i] := RESULT;
  ELSE
    IF *merging-masking*
      THEN
        *DEST[i+63:i] remains unchanged*
      ELSE
        DEST[i+63:i] := 0
    FI
  FI;
ENDFOR
DEST[MAXVL-1:VL] := 0
VCVTTPD2QQS (EVEX encoded version) when src operand is a memory source
(KL, VL) = (2, 128), (4, 256), (8, 512)
SET_ROUNDING_MODE_FOR_THIS_INSTRUCTION(TRUNCATE);
FOR j := 0 TO KL-1
  i := j * 64;
  IF k1[j] OR *no writemask*
    THEN
      IF (EVEX.b == 1)
        THEN
          TEMP := Round(SRC[63:0])
        ELSE
          TEMP := Round(SRC[i+63:i])
      FI;
      IF Is_Not_a_Number(TEMP)
        THEN
          RESULT := 0
        ELSE
        // SATURATION
          IF TEMP > 9,223,372,036,854,775,807
            THEN
              RESULT = 9,223,372,036,854,775,807
            ELSE
              IF TEMP < −9,223,372,036,854,775,808
                THEN
                  RESULT = −9,223,372,036,854,775,808
                ELSE
                  RESULT :=
                Convert_Double_Precision_Floating_Point_To_QuadInteger(TEM
                P)
              FI
          Fi
      FI;
      DEST[i+63:i] := RESULT;
    ELSE
      IF *merging-masking*
        THEN
          *DEST[i+63:i] remains unchanged*
        ELSE
          DEST[i+63:i] := 0
      FI
  FI;
ENDFOR
DEST[MAXVL-1:VL] := 0
```

In some examples, the floating-point conversion circuitry/circuitries 103 comprise(s) a plurality of selectable, based on opcode, etc., conversion circuits. In some examples, a particular conversion circuitry selector 131 is provided by decoder and/or scheduler circuitry. In some examples, this is part of a microoperation.

In some examples, there are one or more FP to integer conversion circuits such as IEEE FP16 (half-precision floating-point), IEEE FP32 (single-precision floating-point), IEEE FP64, Bfloat16, FP8 (8-bit floating point—either a 1-5-2 or 1-4-3 format), and/or 4-bit FP (FP4) conversion circuits.

Execution circuitry 101 may include other circuitry 110 such as vector operation circuitry, ALU circuitry, load/store circuitry etc.

In some examples, the first source 111 and the second source 113 are registers. In some examples, the first source 111 is a register and the second source 113 is a memory location. In some examples, the sources 111 and 113 store packed (vector or SIMD) data. In some examples, the sources 111 and 113 are scalar and only store one data element.

An example of a format for a floating-point scalar comparison with flags instruction is VCVTTxx DST/SRC, SRC. In some examples, VCVTTxx is the opcode mnemonic of the instruction and xx represents the data element type (e.g., FP16, FP32, etc. and integer size). SRC is one or more fields for source operand, such as location information for packed data registers identifiers and/or memory location information. In some examples, DST/SRC is provided at least in part by REG 1044 and SRC is provided at least in part by R/M 1046. In some examples, DST/SRC is provided at least in part by REG 1044 and SRC is provided at least in part by ‘R/M 1046 and SIB BYTE 1004. In some examples, aspects of a prefix are also utilized such as a “R” or “B” field to extend the bits of REG 1044 (“R”) and/or R/M 1046 (“B”).

An example of a format for a floating-point scalar comparison with flags instruction is VCVTTxx DST, SRC1, SRC2. In some examples, VCVTTxx is the opcode mnemonic of the instruction and xx represents the data element type (e.g., FP16, FP32, etc. and integer size). SRC1 is one or more fields for source operand, such as location information for packed data registers identifiers and/or memory location information. In some examples, DST is provided at least in part by REG 1044, SRC1 by VVVV bits of a prefix, and SRC2 is provided at least in part by R/M 1046. In some examples, DST is provided at least in part by REG 1044, SRC1 by VVVV bits of a prefix, SRC2 is provided at least in part by ‘R/M 1046 and SIB BYTE 1004. In some examples, aspects of a prefix are also utilized such as a “R” or “B” field to extend the bits of REG 1044 (“R”) and/or R/M 1046 (“B”).

An example of a format for a floating-point scalar comparison with flags instruction is VCVTTxx DST, SRC. In some examples, VCVTTxx is the opcode mnemonic of the instruction and xx represents the data element type (e.g., FP16, FP32, etc. and integer size). SRC is one or more fields for source operand, such as location information for packed data registers identifiers and/or memory location information. In some examples, DST is provided at least in part by REG 1044 and SRC is provided at least in part by R/M 1046. In some examples, DST is provided at least in part by REG 1044 and SRC is provided at least in part by ‘R/M 1046 and SIB BYTE 1004. In some examples, aspects of a prefix are also utilized such as a “R” or “B” field to extend the bits of REG 1044 (“R”) and/or R/M 1046 (“B”).

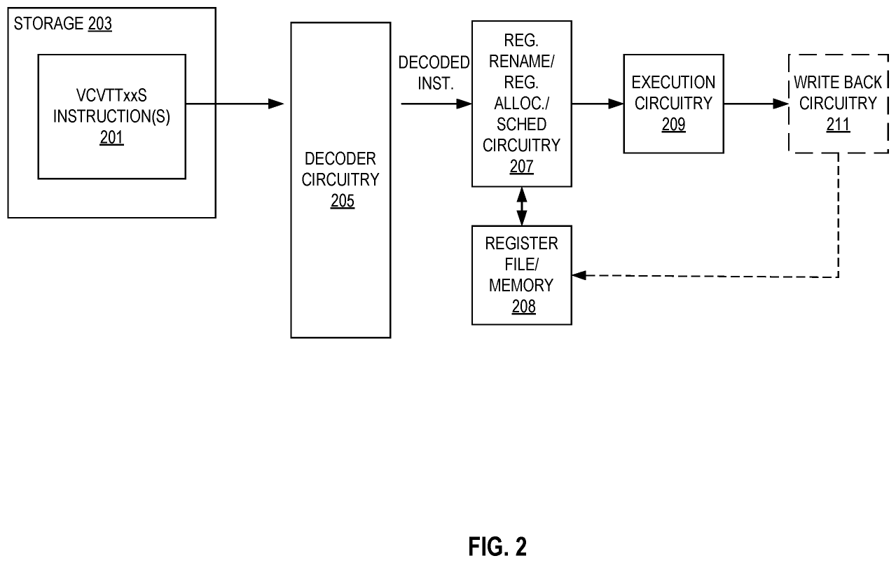

FIG. 2 illustrates examples of computing hardware to process a VCVTTxx instruction. As illustrated, storage 203 stores at least VCVTTxx instruction 201 to be executed. In some examples, storage 203 also stores one or more instructions that use the result of the VCVTTxx instruction.

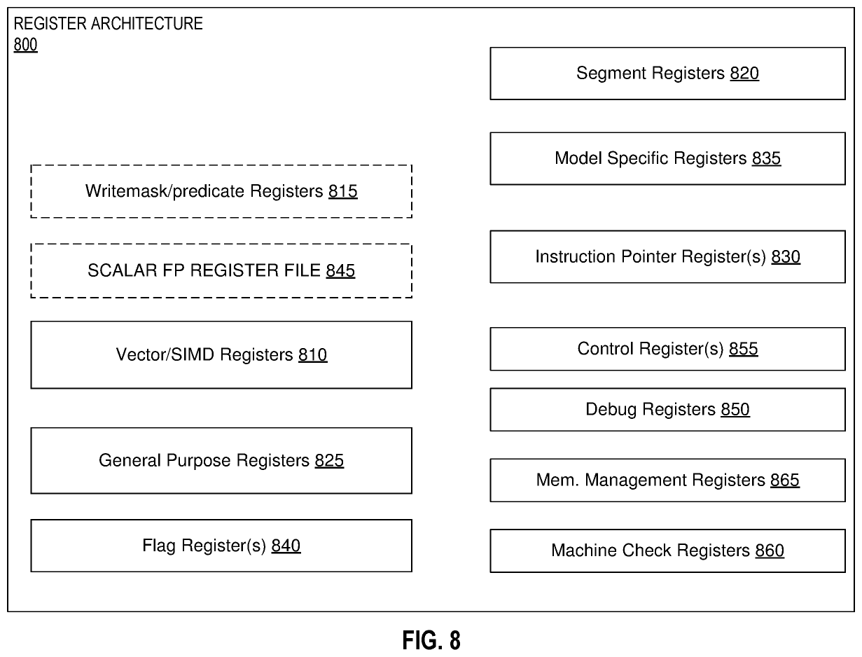

The instruction 201 is received by decoder circuitry 205. For example, the decoder circuitry 205 receives this instruction from fetch circuitry (not shown). The instruction may be in any suitable format, such as that describe with reference to FIG. 9 below. In an example, the instruction includes fields for an opcode and two source operands. In some examples, the sources and destination are registers, and in other examples one or more are memory locations.

More detailed examples of at least one instruction format for the instruction will be detailed later. The decoder circuitry 205 decodes the instruction into one or more operations. In some examples, this decoding includes generating a plurality of micro-operations to be performed by execution circuitry (such as execution circuitry 209). The decoder circuitry 205 also decodes instruction prefixes.

In some examples, register renaming, register allocation, and/or scheduling circuitry 207 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 208 store data as operands of the instruction to be operated by execution circuitry 209. Example register types include packed data registers, general purpose registers (GPRs), and floating-point registers.

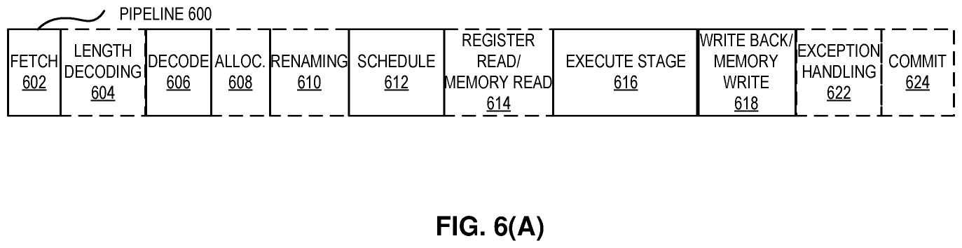

Execution circuitry 209 executes the decoded instruction. Example detailed execution circuitry includes execution circuitry 109 shown in FIG. 1, and execution cluster(s) 660 shown in FIG. 6(B), etc. The execution of the decoded instruction causes the execution circuitry to perform floating-point conversion with truncation to integer using truncation or saturation.

In some examples, retirement/write back circuitry 211 architecturally commits the destination register into the registers or memory 208 and retires the instruction.

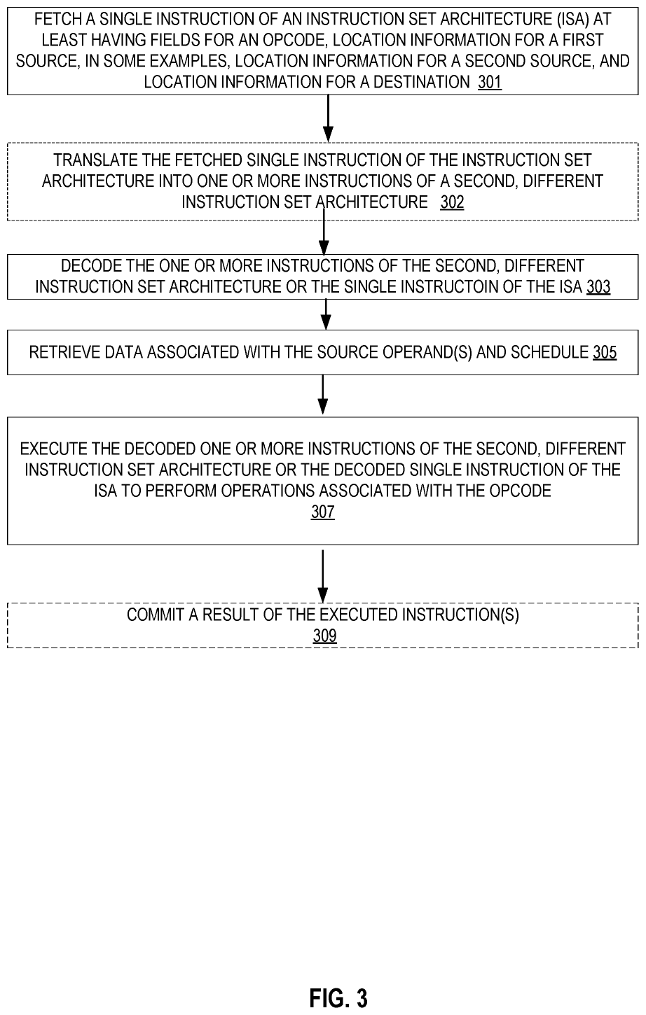

FIG. 3 illustrates an example method to process an instance of a VCVTTxx instruction using circuitry, emulation, and/or binary translation. For example, a processor core as shown in FIG. 6(B), FIG. 1, FIG. ‘ISAE, a pipeline and/or emulation/translation layer perform aspects of this method.

An instance of a single instruction (VCVTTxx) of an instruction set architecture is fetched at 301. The instance of the single instruction of the first instruction set architecture at least includes fields for an opcode, a source operand(s) location information (e.g., memory addressing information and/or register identifier(s)), and destination operand location information. In some examples, the instruction further includes a prefix. In some examples, the instruction is fetched from an instruction cache. The opcode indicates execution circuitry, such as that detailed herein, is to

```
If embedded rounding is selected,
  Set invalid_signling to false
  Set rounding_mode to selected rounding mode
Otherwise
  Set invalid_signaling to not MXSCR.IM
  Set rounding_mode to truncation
If the source value is Not-a-Number,
  Set result to zero
  If invalid_signaling,
    Signal invalid
Otherwise,
  Set rounded_source = round(source, rounding_mode)
  If rounded_source is greater than maximum_possible_result
    If invalid_signaling,
      Signal invalid
    Set result to maximum_possible_result
Otherwise,
  If rounded_source is less than minimum_possible_result
    Set result to minimum_possible_result
    If invalid_signaling,
      Signal invalid
Otherwise
// perform conversion as required by the specific FP datatype and size
  Set result to rounded_source converted to the result type
```

In some examples, the sources are registers and the destination is a register. In some examples, the destination is a register and one of the sources is a memory location. The opcode may also indicate data types such as FP4, FP8, FP16, FP32, FP64, BF16, etc. In some examples, the source stores packed data (e.g., vector or SIMD data). In some examples, the destination and source are scalar.

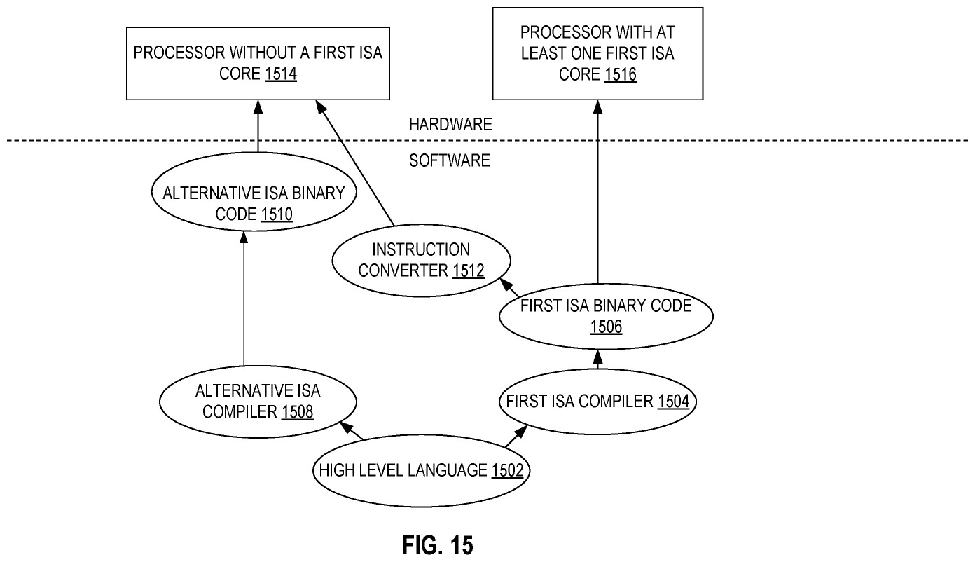

The fetched single instruction of the instruction set architecture is translated into one or more instructions of a second, different instruction set architecture in some examples at 302. This translation is performed by a translation and/or emulation layer of software in some examples. In some examples, this translation is performed by an instruction converter 1512 as shown in FIG. 15. In some examples, the translation is performed by hardware translation circuitry.

The one or more translated instructions of the second, different instruction set architecture are decoded or the single instruction of the ISA is decoded at 403. For example, the translated instructions or single instruction are/is decoded by decoder circuitry such as decoder circuitry 205 or decode circuitry 640 detailed herein. In some examples, the operations of translation and decoding at 302 and 303 are merged.

Data values associated with the source operand(s) of the decoded instruction(s) of the second, different instruction set architecture or decoded single instruction are retrieved and the one or more instructions are scheduled at 305. For example, when the source operand is memory operand, the data from the indicated memory location is retrieved.

At 307, the decoded instruction(s) of the second, different instruction set architecture or the decoded single instruction is/are executed by execution circuitry (hardware) such as one or more of execution circuitry 209 shown in FIG. 2, execution circuitry 101, execution cluster(s) 660 shown in FIG. 6(B), etc. to perform the operation(s) indicated by the opcode of the single instruction of the first instruction set architecture. For the VCVTTxx instruction, the execution will cause execution circuitry to perform operations such as

```
If embedded rounding is selected,
  Set invalid_signling to false
  Set rounding_mode to selected rounding mode
Otherwise
// MXCSR is control register and IM is an invalid operation mask
  Set invalid_signaling to not MXCSR.IM
  Set rounding_mode to truncation
If the source value is Not-a-Number,
  Set result to zero
  If invalid_signaling,
    Signal invalid
Otherwise,
  Set rounded_source = round(source, rounding_mode)
  If rounded_source is greater than maximum_possible_result
    If invalid_signaling,
      Signal invalid
// SATURATION
    Set result to maximum_possible_result
Otherwise,
  If rounded_source is less than minimum_possible_result
// SATURATION
    Set result to minimum_possible_result
    If invalid_signaling,
      Signal invalid
Otherwise
// perform conversion as required by the specific FP datatype and size
  Set result to rounded_source converted to the result type
```

In some examples, the instruction(s) is/are committed or retired at 309.

Examples of computer architectures, pipelines, instruction formats, systems, etc. that support examples of VCVTTxx are detailed below.

Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

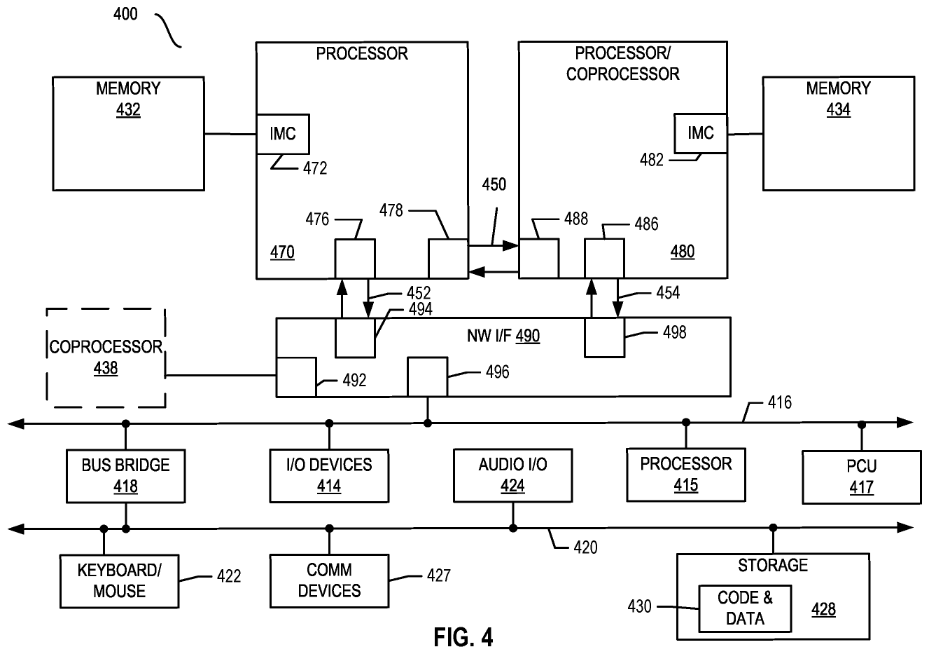

FIG. 4 illustrates an example computing system. Multiprocessor system 400 is an interfaced system and includes a plurality of processors or cores including a first processor 470 and a second processor 480 coupled via an interface 450 such as a point-to-point (P-P) interconnect, a fabric, and/or bus. In some examples, the first processor 470 and the second processor 480 are homogeneous. In some examples, the first processor 470 and the second processor 480 are heterogenous. Though the example system 400 is shown to have two processors, the system may have three or more processors, or may be a single processor system. In some examples, the computing system is a system on a chip (SoC).

Processors 470 and 480 are shown including integrated memory controller (IMC) circuitry 472 and 482, respectively. Processor 470 also includes interface circuits 476 and 478; similarly, second processor 480 includes interface circuits 486 and 488. Processors 470, 480 may exchange information via the interface 450 using interface circuits 478, 488. IMCs 472 and 482 couple the processors 470, 480 to respective memories, namely a memory 432 and a memory 434, which may be portions of main memory locally attached to the respective processors.

Processors 470, 480 may each exchange information with a network interface (NW I/F) 490 via individual interfaces 452, 454 using interface circuits 476, 494, 486, 498. The network interface 490 (e.g., one or more of an interconnect, bus, and/or fabric, and in some examples is a chipset) may optionally exchange information with a coprocessor 438 via an interface circuit 492. In some examples, the coprocessor 438 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 470, 480 or outside of both processors, yet connected with the processors via an interface such as P-P interconnect, such that either or both processors' local cache information may be stored in the shared cache if a processor is placed into a low power mode.

Network interface 490 may be coupled to a first interface 416 via interface circuit 496. In some examples, first interface 416 may be an interface such as a Peripheral Component Interconnect (PCI) interconnect, a PCI Express interconnect or another I/O interconnect. In some examples, first interface 416 is coupled to a power control unit (PCU) 417, which may include circuitry, software, and/or firmware to perform power management operations with regard to the processors 470, 480 and/or co-processor 438. PCU 417 provides control information to a voltage regulator (not shown) to cause the voltage regulator to generate the appropriate regulated voltage. PCU 417 also provides control information to control the operating voltage generated. In various examples, PCU 417 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 417 is illustrated as being present as logic separate from the processor 470 and/or processor 480. In other cases, PCU 417 may execute on a given one or more of cores (not shown) of processor 470 or 480. In some cases, PCU 417 may be implemented as a microcontroller (dedicated or general-purpose) or other control logic configured to execute its own dedicated power management code, sometimes referred to as P-code. In yet other examples, power management operations to be performed by PCU 417 may be implemented externally to a processor, such as by way of a separate power management integrated circuit (PMIC) or another component external to the processor. In yet other examples, power management operations to be performed by PCU 417 may be implemented within BIOS or other system software.

Various I/O devices 414 may be coupled to first interface 416, along with a bus bridge 418 which couples first interface 416 to a second interface 420. In some examples, one or more additional processor(s) 415, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 416. In some examples, second interface 420 may be a low pin count (LPC) interface. Various devices may be coupled to second interface 420 including, for example, a keyboard and/or mouse 422, communication devices 427 and storage circuitry 428. Storage circuitry 428 may be one or more non-transitory machine-readable storage media as described below, such as a disk drive or other mass storage device which may include instructions/code and data 430 and may implement the storage 203 in some examples. Further, an audio I/O 424 may be coupled to second interface 420. Note that other architectures than the point-to-point architecture described above are possible. For example, instead of the point-to-point architecture, a system such as multiprocessor system 400 may implement a multi-drop interface or other such architecture.

Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

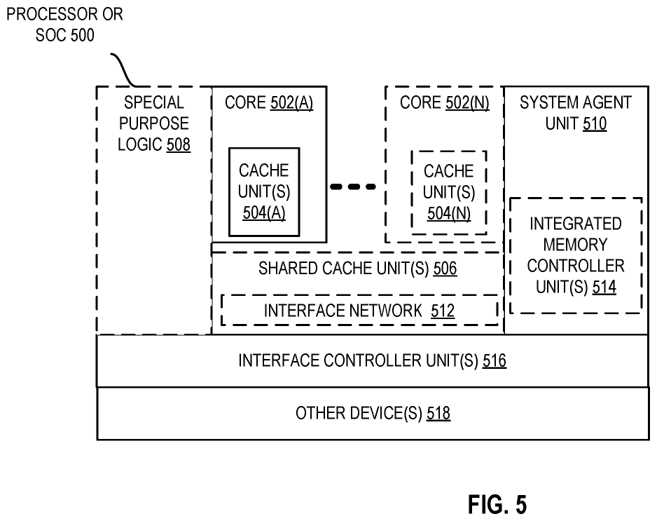

FIG. 5 illustrates a block diagram of an example processor and/or SoC 500 that may have one or more cores and an integrated memory controller. The solid lined boxes illustrate a processor 500 with a single core 502(A), system agent unit circuitry 510, and a set of one or more interface controller unit(s) circuitry 516, while the optional addition of the dashed lined boxes illustrates an alternative processor 500 with multiple cores 502(A)-(N), a set of one or more integrated memory controller unit(s) circuitry 514 in the system agent unit circuitry 510, and special purpose logic 508, as well as a set of one or more interface controller units circuitry 516. Note that the processor 500 may be one of the processors 470 or 480, or co-processor 438 or 415 of FIG. 4.

Thus, different implementations of the processor 500 may include: 1) a CPU with the special purpose logic 508 being integrated graphics and/or scientific (throughput) logic (which may include one or more cores, not shown), and the cores 502(A)-(N) being one or more general purpose cores (e.g., general purpose in-order cores, general purpose out-of-order cores, or a combination of the two); 2) a coprocessor with the cores 502(A)-(N) being a large number of special purpose cores intended primarily for graphics and/or scientific (throughput); and 3) a coprocessor with the cores 502(A)-(N) being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (N MOS).

A memory hierarchy includes one or more levels of cache unit(s) circuitry 504(A)-(N) within the cores 502(A)-(N), a set of one or more shared cache unit(s) circuitry 506, and external memory (not shown) coupled to the set of integrated memory controller unit(s) circuitry 514. The set of one or more shared cache unit(s) circuitry 506 may include one or more mid-level caches, such as level 2 (L2), level 3 (L3), level 4 (L4), or other levels of cache, such as a last level cache (LLC), and/or combinations thereof. While in some examples interface network circuitry 512 (e.g., a ring interconnect) interfaces the special purpose logic 508 (e.g., integrated graphics logic), the set of shared cache unit(s) circuitry 506, and the system agent unit circuitry 510, alternative examples use any number of well-known techniques for interfacing such units. In some examples, coherency is maintained between one or more of the shared cache unit(s) circuitry 506 and cores 502(A)-(N). In some examples, interface controller units circuitry 516 couple the cores 502 to one or more other devices 518 such as one or more I/O devices, storage, one or more communication devices (e.g., wireless networking, wired networking, etc.), etc.

In some examples, one or more of the cores 502(A)-(N) are capable of multi-threading. The system agent unit circuitry 510 includes those components coordinating and operating cores 502(A)-(N). The system agent unit circuitry 510 may include, for example, power control unit (PCU) circuitry and/or display unit circuitry (not shown). The PCU may be or may include logic and components needed for regulating the power state of the cores 502(A)-(N) and/or the special purpose logic 508 (e.g., integrated graphics logic). The display unit circuitry is for driving one or more externally connected displays.

The cores 502(A)-(N) may be homogenous in terms of instruction set architecture (ISA). Alternatively, the cores 502(A)-(N) may be heterogeneous in terms of ISA; that is, a subset of the cores 502(A)-(N) may be capable of executing an ISA, while other cores may be capable of executing only a subset of that ISA or another ISA.

Example Core Architectures—In-order and out-of-order core block diagram.

FIG. 6(A) is a block diagram illustrating both an example in-order pipeline and an example register renaming, out-of-order issue/execution pipeline according to examples. FIG. 6(B) is a block diagram illustrating both an example in-order architecture core and an example register renaming, out-of-order issue/execution architecture core to be included in a processor according to examples. The solid lined boxes in FIGS. 6(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6(A), a processor pipeline 600 includes a fetch stage 602, an optional length decoding stage 604, a decode stage 606, an optional allocation (Alloc) stage 608, an optional renaming stage 610, a schedule (also known as a dispatch or issue) stage 612, an optional register read/memory read stage 614, an execute stage 616, a write back/memory write stage 618, an optional exception handling stage 622, and an optional commit stage 624. One or more operations can be performed in each of these processor pipeline stages. For example, during the fetch stage 602, one or more instructions are fetched from instruction memory, and during the decode stage 606, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 606 and the register read/memory read stage 614 may be combined into one pipeline stage. In one example, during the execute stage 616, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 6(B) may implement the pipeline 600 as follows: 1) the instruction fetch circuitry 638 performs the fetch and length decoding stages 602 and 604; 2) the decode circuitry 640 performs the decode stage 606; 3) the rename/allocator unit circuitry 652 performs the allocation stage 608 and renaming stage 610; 4) the scheduler(s) circuitry 656 performs the schedule stage 612; 5) the physical register file(s) circuitry 658 and the memory unit circuitry 670 perform the register read/memory read stage 614; the execution cluster(s) 660 perform the execute stage 616; 6) the memory unit circuitry 670 and the physical register file(s) circuitry 658 perform the write back/memory write stage 618; 7) various circuitry may be involved in the exception handling stage 622; and 8) the retirement unit circuitry 654 and the physical register file(s) circuitry 658 perform the commit stage 624.

FIG. 6(B) shows a processor core 690 including front-end unit circuitry 630 coupled to execution engine unit circuitry 650, and both are coupled to memory unit circuitry 670. The core 690 may be a reduced instruction set architecture computing (RISC) core, a complex instruction set architecture computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front-end unit circuitry 630 may include branch prediction circuitry 632 coupled to instruction cache circuitry 634, which is coupled to an instruction translation lookaside buffer (TLB) 636, which is coupled to instruction fetch circuitry 638, which is coupled to decode circuitry 640. In one example, the instruction cache circuitry 634 is included in the memory unit circuitry 670 rather than the front-end circuitry 630. The decode circuitry 640 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 640 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 640 may be implemented using various different mechanisms. Examples of suitable mechanisms include, but are not limited to, look-up tables, hardware implementations, programmable logic arrays (PLAs), microcode read only memories (ROMs), etc. In one example, the core 690 includes a microcode ROM (not shown) or other medium that stores microcode for certain macroinstructions (e.g., in decode circuitry 640 or otherwise within the front-end circuitry 630). In one example, the decode circuitry 640 includes a micro-operation (micro-op) or operation cache (not shown) to hold/cache decoded operations, micro-tags, or micro-operations generated during the decode or other stages of the processor pipeline 600. The decode circuitry 640 may be coupled to rename/allocator unit circuitry 652 in the execution engine circuitry 650.

The execution engine circuitry 650 includes the rename/allocator unit circuitry 652 coupled to retirement unit circuitry 654 and a set of one or more scheduler(s) circuitry 656. The scheduler(s) circuitry 656 represents any number of different schedulers, including reservations stations, central instruction window, etc. In some examples, the scheduler(s) circuitry 656 can include arithmetic logic unit (ALU) scheduler/scheduling circuitry, ALU queues, address generation unit (AGU) scheduler/scheduling circuitry, AGU queues, etc. The scheduler(s) circuitry 656 is coupled to the physical register file(s) circuitry 658. Each of the physical register file(s) circuitry 658 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 658 includes vector registers unit circuitry, writemask registers unit circuitry, and scalar register unit circuitry. These register units may provide architectural vector registers, vector mask registers, general-purpose registers, etc. The physical register file(s) circuitry 658 is coupled to the retirement unit circuitry 654 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 654 and the physical register file(s) circuitry 658 are coupled to the execution cluster(s) 660. The execution cluster(s) 660 includes a set of one or more execution unit(s) circuitry 662 and a set of one or more memory access circuitry 664. The execution unit(s) circuitry 662 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 656, physical register file(s) circuitry 658, and execution cluster(s) 660 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 664). It should also be understood that where separate pipelines are used, one or more of these pipelines may be out-of-order issue/execution and the rest in-order.

In some examples, the execution engine unit circuitry 650 may perform load store unit (LSU) address/data pipelining to an Advanced Microcontroller Bus (AMB) interface (not shown), and address phase and writeback, data phase load, store, and branches.

The set of memory access circuitry 664 is coupled to the memory unit circuitry 670, which includes data TLB circuitry 672 coupled to data cache circuitry 674 coupled to level 2 (L2) cache circuitry 676. In one example, the memory access circuitry 664 may include load unit circuitry, store address unit circuitry, and store data unit circuitry, each of which is coupled to the data TLB circuitry 672 in the memory unit circuitry 670. The instruction cache circuitry 634 is further coupled to the level 2 (L2) cache circuitry 676 in the memory unit circuitry 670. In one example, the instruction cache 634 and the data cache 674 are combined into a single instruction and data cache (not shown) in L2 cache circuitry 676, level 3 (L3) cache circuitry (not shown), and/or main memory. The L2 cache circuitry 676 is coupled to one or more other levels of cache and eventually to a main memory.

The core 690 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 690 includes logic to support a packed data instruction set architecture extension (e.g., AVX1, AVX2), thereby allowing the operations used by many multimedia applications to be performed using packed data.

Example Execution Unit(s) Circuitry.

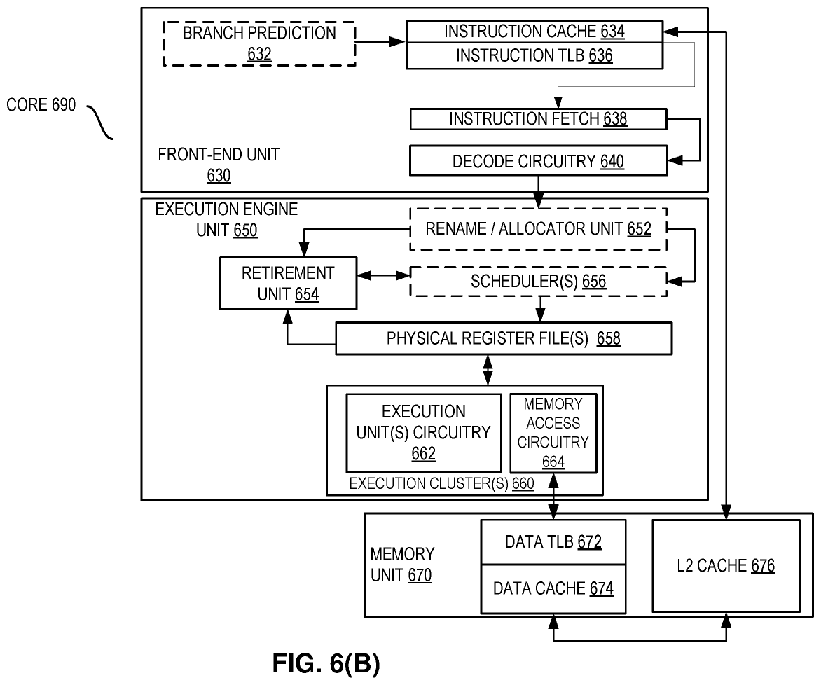

FIG. 7 illustrates examples of execution unit(s) circuitry, such as execution unit(s) circuitry 662 of FIG. 6(B). As illustrated, execution unit(s) circuitry 662 may include one or more ALU circuits 701, optional vector/single instruction multiple data (SIMD) circuits 703, load/store circuits 705, branch/jump circuits 707, and/or Floating-point unit (FPU) circuits 709. ALU circuits 701 perform integer arithmetic and/or Boolean operations. Vector/SIMD circuits 703 perform vector/SIMD operations on packed data (such as SIMD/vector registers). Load/store circuits 705 execute load and store instructions to load data from memory into registers or store from registers to memory. Load/store circuits 705 may also generate addresses. Branch/jump circuits 707 cause a branch or jump to a memory address depending on the instruction. FPU circuits 709 perform floating-point arithmetic. The width of the execution unit(s) circuitry 662 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Example Register Architecture.

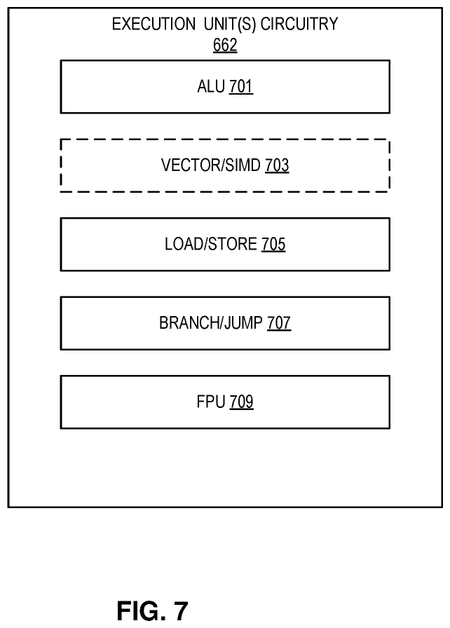

FIG. 8 is a block diagram of a register architecture 800 according to some examples. As illustrated, the register architecture 800 includes vector/SIMD registers 810 that vary from 128-bit to 1,024 bits width. In some examples, the vector/SIMD registers 810 are physically 512-bits and, depending upon the mapping, only some of the lower bits are used. For example, in some examples, the vector/SIMD registers 810 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 800 includes writemask/predicate registers 815. For example, in some examples, there are 8 writemask/predicate registers (sometimes called k0 through k7) that are each 16-bit, 32-bit, 64-bit, or 128-bit in size. Writemask/predicate registers 815 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 815 corresponds to a data element position of the destination. In other examples, the writemask/predicate registers 815 are scalable and consists of a set number of enable bits for a given vector element (e.g., 8 enable bits per 64-bit vector element).

The register architecture 800 includes a plurality of general-purpose registers 825. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 800 includes scalar floating-point (FP) register file 845 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 840 (e.g., EFLAGS, RFLAGS, etc.) store status and control information for arithmetic, compare, and system operations. For example, the one or more flag registers 840 may store condition code information such as carry, parity, auxiliary carry, zero, sign, and overflow. In some examples, the one or more flag registers 840 are called program status and control registers.

Segment registers 820 contain segment points for use in accessing memory. In some examples, these registers are referenced by the names CS, DS, SS, ES, FS, and GS.

Model specific registers or machine specific registers (MSRs) 835 control and report on processor performance. Most MSRs 835 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 860 consist of control, status, and error reporting MSRs that are used to detect and report on hardware errors. Control register(s) 855 (e.g., CR0-CR4) determine the operating mode of a processor (e.g., processor 470, 480, 438, 415, and/or 500) and the characteristics of a currently executing task. In some examples, MSRs 835 are a subset of control registers 855.

One or more instruction pointer register(s) 830 store an instruction pointer value. Debug registers 850 control and allow for the monitoring of a processor or core's debugging operations.

Memory (mem) management registers 865 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 800 may, for example, be used in register file/memory 208, or physical register file(s) circuitry 658.

Instruction set architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 9 illustrates examples of an instruction format. As illustrated, an instruction may include multiple components including, but not limited to, one or more fields for: one or more prefixes 901, an opcode 903, addressing information 905 (e.g., register identifiers, memory addressing information, etc.), a displacement value 907, and/or an immediate value 909. Note that some instructions utilize some or all the fields of the format whereas others may only use the field for the opcode 903. In some examples, the order illustrated is the order in which these fields are to be encoded, however, it should be appreciated that in other examples these fields may be encoded in a different order, combined, etc.

The prefix(es) field(s) 901, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 903 is used to at least partially define the operation to be performed upon a decoding of the instruction. In some examples, a primary opcode encoded in the opcode field 903 is one, two, or three bytes in length. In other examples, a primary opcode can be a different length. An additional 3-bit opcode field is sometimes encoded in another field.

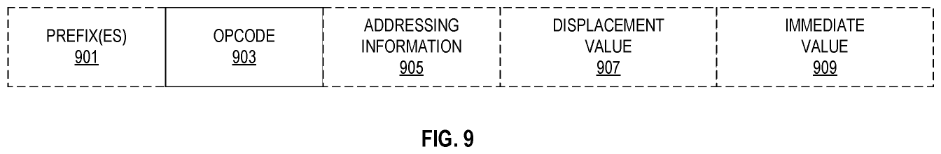

The addressing information field 905 is used to address one or more operands of the instruction, such as a location in memory or one or more registers. FIG. 10 illustrates examples of the addressing information field 905. In this illustration, an optional MOD R/M byte 1002 and an optional Scale, Index, Base (SIB) byte 1004 are shown. The MOD RIM byte 1002 and the SIB byte 1004 are used to encode up to two operands of an instruction, each of which is a direct register or effective memory address. Note that both of these fields are optional in that not all instructions include one or more of these fields. The MOD RIM byte 1002 includes a MOD field 1042, a register (reg) field 1044, and R/M field 1046.

The content of the MOD field 1042 distinguishes between memory access and non-memory access modes. In some examples, when the MOD field 1042 has a binary value of 11 (11b), a register-direct addressing mode is utilized, and otherwise a register-indirect addressing mode is used.

The register field 1044 may encode either the destination register operand or a source register operand or may encode an opcode extension and not be used to encode any instruction operand. The content of register field 1044, directly or through address generation, specifies the locations of a source or destination operand (either in a register or in memory). In some examples, the register field 1044 is supplemented with an additional bit from a prefix (e.g., prefix 901) to allow for greater addressing.

The RIM field 1046 may be used to encode an instruction operand that references a memory address or may be used to encode either the destination register operand or a source register operand. Note the RIM field 1046 may be combined with the MOD field 1042 to dictate an addressing mode in some examples.

The SIB byte 1004 includes a scale field 1052, an index field 1054, and a base field 1056 to be used in the generation of an address. The scale field 1052 indicates a scaling factor. The index field 1054 specifies an index register to use. In some examples, the index field 1054 is supplemented with an additional bit from a prefix (e.g., prefix 901) to allow for greater addressing. The base field 1056 specifies a base register to use. In some examples, the base field 1056 is supplemented with an additional bit from a prefix (e.g., prefix 901) to allow for greater addressing. In practice, the content of the scale field 1052 allows for the scaling of the content of the index field 1054 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 907 provides this value. Additionally, in some examples, a displacement factor usage is encoded in the MOD field of the addressing information field 905 that indicates a compressed displacement scheme for which a displacement value is calculated and stored in the displacement field 907.

In some examples, the immediate value field 909 specifies an immediate value for the instruction. An immediate value may be encoded as a 1-byte value, a 2-byte value, a 4-byte value, etc.

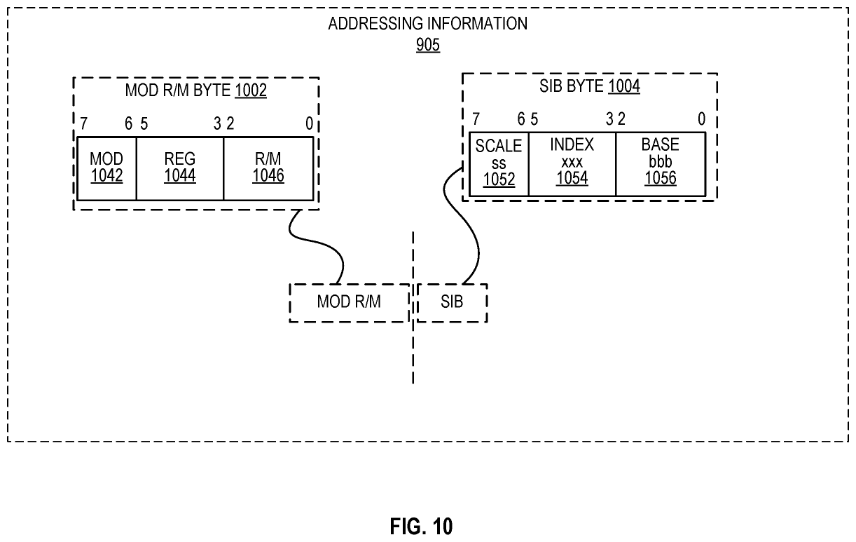

FIG. 11 illustrates examples of a first prefix 901(A). In some examples, the first prefix 901(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 901(A) may specify up to three registers using 3-bit fields depending on the format: 1) using the reg field 1044 and the R/M field 1046 of the MOD R/M byte 1002; 2) using the MOD R/M byte 1002 with the SIB byte 1004 including using the reg field 1044 and the base field 1056 and index field 1054; or 3) using the register field of an opcode.

In the first prefix 901(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1044 and MOD R/M R/M field 1046 alone can each only address 8 registers.

In the first prefix 901(A), bit position 2 (R) may be an extension of the MOD R/M reg field 1044 and may be used to modify the MOD R/M reg field 1044 when that field encodes a general-purpose register, a 64-bit packed data register (e.g., an SSE register), or a control or debug register. R is ignored when MOD R/M byte 1002 specifies other registers or defines an extended opcode.

Bit position 1 (X) may modify the SIB byte index field 1054.

Bit position 0 (B) may modify the base in the MOD RIM RIM field 1046 or the SIB byte base field 1056; or it may modify the opcode register field used for accessing general purpose registers (e.g., general purpose registers 825).

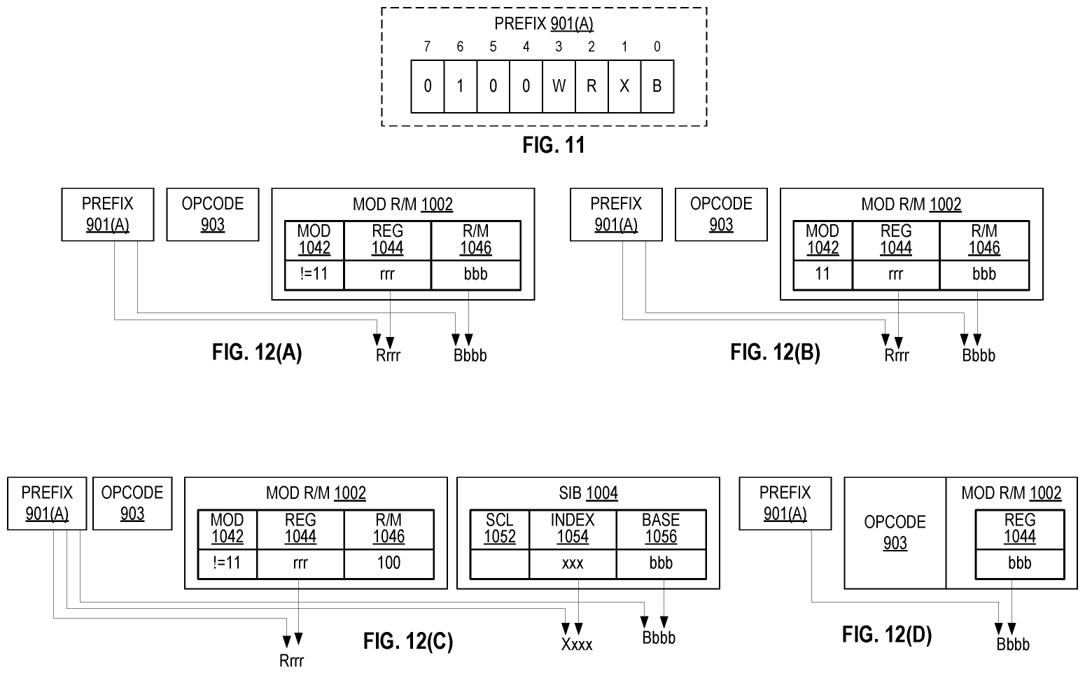

FIGS. 12(A)-(D) illustrate examples of how the R, X, and B fields of the first prefix 901(A) are used. FIG. 12(A) illustrates R and B from the first prefix 901(A) being used to extend the reg field 1044 and RIM field 1046 of the MOD RIM byte 1002 when the SIB byte 10 04 is not used for memory addressing. FIG. 12(B) illustrates R and B from the first prefix 901(A) being used to extend the reg field 1044 and RIM field 1046 of the MOD RIM byte 1002 when the SIB byte 10 04 is not used (register-register addressing). FIG. 12(C) illustrates R, X, and B from the first prefix 901(A) being used to extend the reg field 1044 of the MOD RIM byte 1002 and the index field 1054 and base field 1056 when the SIB byte 10 04 being used for memory addressing. FIG. 12(D) illustrates B from the first prefix 901(A) being used to extend the reg field 1044 of the MOD RIM byte 1002 when a register is encoded in the opcode 903.

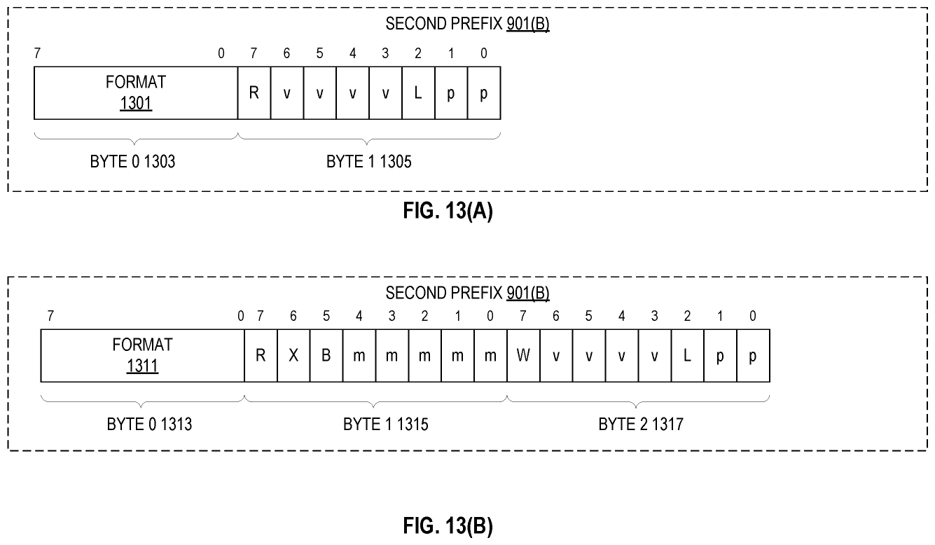

FIGS. 13(A)-(B) illustrate examples of a second prefix 901(B). In some examples, the second prefix 901(B) is an example of a VEX prefix. The second prefix 901(B) encoding allows instructions to have more than two operands, and allows SIMD vector registers (e.g., vector/SIMD registers 810) to be longer than 64-bits (e.g., 128-bit and 256-bit). The use of the second prefix 901(B) provides for three-operand (or more) syntax. For example, previous two-operand instructions performed operations such as A=A+B, which overwrites a source operand. The use of the second prefix 901(B) enables operands to perform nondestructive operations such as A=B+C.

In some examples, the second prefix 901(B) comes in two forms—a two-byte form and a three-byte form. The two-byte second prefix 901(B) is used mainly for 128-bit, scalar, and some 256-bit instructions; while the three-byte second prefix 901(B) provides a compact replacement of the first prefix 901(A) and 3-byte opcode instructions.

FIG. 13(A) illustrates examples of a two-byte form of the second prefix 901(B). In one example, a format field 1301 (byte 0 1303) contains the value CSH. In one example, byte 1 1305 includes an “R” value in bit[7]. This value is the complement of the “R” value of the first prefix 901(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD RIM RIM field 1046 to encode the instruction operand that references a memory address or encode either the destination register operand or a source register operand.

Instructions that use this prefix may use the MOD RIM reg field 1044 to encode either the destination register operand or a source register operand, or to be treated as an opcode extension and not used to encode any instruction operand.

For instruction syntax that support four operands, vvvv, the MOD RIM RIM field 1046 and the MOD RIM reg field 1044 encode three of the four operands. Bits[7:4] of the immediate value field 909 are then used to encode the third source register operand.

FIG. 13(B) illustrates examples of a three-byte form of the second prefix 901(B). In one example, a format field 1311 (byte 0 1313) contains the value C4H. Byte 1 1315 includes in bits[7:5] “R,” “X,” and “B” which are the complements of the same values of the first prefix 901(A). Bits[4:0] of byte 1 1315 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1317 is used similar to W of the first prefix 901(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD RIM RIM field 1046 to encode the instruction operand that references a memory address or encode either the destination register operand or a source register operand.

Instructions that use this prefix may use the MOD RIM reg field 1044 to encode either the destination register operand or a source register operand, or to be treated as an opcode extension and not used to encode any instruction operand.

For instruction syntax that support four operands, vvvv, the MOD RIM RIM field 1046, and the MOD RIM reg field 1044 encode three of the four operands. Bits[7:4] of the immediate value field 909 are then used to encode the third source register operand.

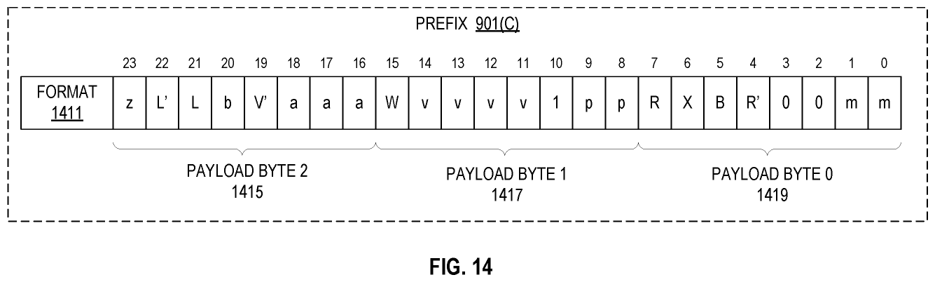

FIG. 14 illustrates examples of a third prefix 901(C). In some examples, the third prefix 901(C) is an example of an EVEX prefix. The third prefix 901(C) is a four-byte prefix.

The third prefix 901(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 8) or predication utilize this prefix. Opmask register allow for conditional processing or selection control. Opmask instructions, whose source/destination operands are opmask registers and treat the content of an opmask register as a single value, are encoded using the second prefix 901(B).

The third prefix 901(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 901(C) is a format field 1411 that has a value, in one example, of 62H. Subsequent bytes are referred to as payload bytes 1415-1419 and collectively form a 24-bit value of P[23:0] providing specific capability in the form of one or more fields (detailed herein).

In some examples, P[1:0] of payload byte 1419 are identical to the low two mm bits. P[3:2] are reserved in some examples. Bit P[4] (R′) allows access to the high 16 vector register set when combined with P[7] and the MOD RIM reg field 1044. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1044 and MOD R/M R/M field 1046. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 901(A) and second prefix 911(B) and may serve as an opcode extension bit or operand size promotion.

P[18:16] specify the index of a register in the opmask (writemask) registers (e.g., writemask/predicate registers 815). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 901(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | Mod R/M | GPR, Vector | Destination or Source |
| | | | reg | | |
| VVVV | V′ | vvvv | | GPR, Vector | 2nd Source or Destination |
| RM | X | B | Mod R/M | GPR, Vector | 1st Source or Destination |
| | | | R/M | | |
| BASE | 0 | B | Mod R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | Mod R/M reg | GPR, Vector | Destination or Source |
| VVVV | vvvv | GPR, Vector | 2^{nd} Source or Destination |
| RM | Mod R/M R/M | GPR, Vector | 1^{st} Source or Destination |
| BASE | Mod R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | Mod R/M Reg | k0-k7 | Source |
| VVVV | vvvv | k0-k7 | 2^{nd} Source |
| RM | Mod R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 15 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 15 shows a program in a high-level language 1502 may be compiled using a first ISA compiler 1504 to generate first ISA binary code 1506 that may be natively executed by a processor with at least one first ISA core 1516. The processor with at least one first ISA core 1516 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1504 represents a compiler that is operable to generate first ISA binary code 1506 (e.g., object code) that can, with or without additional linkage processing, be executed on the processor with at least one first ISA core 1516. Similarly, FIG. 15 shows the program in the high-level language 1502 may be compiled using an alternative ISA compiler 1508 to generate alternative ISA binary code 1510 that may be natively executed by a processor without a first ISA core 1514. The instruction converter 1512 is used to convert the first ISA binary code 1506 into code that may be natively executed by the processor without a first ISA core 1514. This converted code is not necessarily to be the same as the alternative ISA binary code 1510; however, the converted code will accomplish the general operation and be made up of instructions from the alternative ISA. Thus, the instruction converter 1512 represents software, firmware, hardware, or a combination thereof that, through emulation, simulation or any other process, allows a processor or other electronic device that does not have a first ISA processor or core to execute the first ISA binary code 1506.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Examples include, but are not limited to:
Example 1. An apparatus such as a processor, SoC, core, accelerator, etc. that at least includes decoder circuitry to decode an instance of a single instruction, the instance of the single instruction to include at least one or more fields for an opcode, one or more fields for location information for at least a first source operand and a destination operand, wherein the opcode is to indicate that execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows; and execution circuitry that is to execute the decoded instance of the single instruction according to the opcode.
Example 2. The apparatus of example 1, wherein the one or more fields for location information for the first source operand are to identify a vector register.
Example 3. The apparatus of example 1, wherein the one or more fields for location information for the first source operand to provide memory location information.
Example 4. The apparatus of any of examples 1-3, wherein each of the floating-point values of the first source operand is to have a type that is one of a 4-bit floating point value, an 8-bit floating point value, a 16-bit floating point value, a 32-bit floating point value, or a 64-bit floating point value.
Example 5. The apparatus of example 4, wherein the type is identified by the opcode.
Example 6. The apparatus of any of examples 1-5, wherein the instance of the single instruction further comprises one or more fields to provide location information for a second source operand.
Example 7. The apparatus of any of examples 1-6, wherein the instance of the single instruction is to indicate a rounding mode to be applied.
Example 8. A method to convert data elements using that at least comprises decoding instance of a single instruction that includes at least one or more fields for an opcode and one or more fields for location information for at least a first source operand and a destination operand, wherein the opcode is to indicate execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows; decoding the one instruction; and executing the decoded instruction. In some instances translation, etc. is performed the single instruction and those translated one or more instructions are decoded and executed as detailed above.
Example 9. The method of example 8, wherein the one or more fields for location information for the first source operand are to identify a vector register.
Example 10. The method of example 8, wherein the one or more fields for location information for the first source operand to provide memory location information.
Example 11. The method of any of examples 8-10, wherein each of the floating-point values of the first source operand is to have a type that is one of a 4-bit floating point value, an 8-bit floating point value, a 16-bit floating point value, a 32-bit floating point value, or a 64-bit floating point value.
Example 12. The method of example 11, wherein the type is identified by the opcode.
Example 13. The method of any of examples 8-12, wherein the instance of the single instruction further comprises one or more fields to provide location information for a second source operand.
Example 14. The method of any of examples 8-13, wherein the instance of the single instruction is to indicate a rounding mode to be applied.
Example 15. A system such as a computer, SoC, hardware device, etc. that at least comprises memory to store at least an instance of a single instruction; decoder circuitry to decode the instance of the single instruction, the instance of the single instruction to include at least one or more fields for an opcode and one or more fields for location information for at least a first source operand and a destination operand, wherein the opcode is to indicate execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows, wherein the decoder circuitry is to support instructions other than the single instruction; and the execution circuitry to execute the decoded instance of the single instruction according to the opcode.
Example 16. The system of example 15, wherein the one or more fields for location information for the first source operand are to identify a vector register.
Example 17. The system of example 15, wherein the one or more fields for location information for the first source operand to provide memory location information.
Example 18. The system of any of examples 15-17, wherein each of the floating-point values of the first source operand is to have a type that is one of a 4-bit floating point value, an 8-bit floating point value, a 16-bit floating point value, a 32-bit floating point value, or a 64-bit floating point value.
Example 19. The system of example 18, wherein the type is identified by the opcode.
Example 20. The system of any of examples 15-19, wherein the instance of the single instruction further comprises one or more fields to provide location information for a second source operand.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode an instance of a single instruction, the instance of the single instruction to include at least one or more fields for an opcode, one or more fields for location information for at least a first source operand and a destination operand, wherein the opcode is to indicate that execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows; and
the execution circuitry to execute the decoded instance of the single instruction according to the opcode.

2. The apparatus of claim 1, wherein the one or more fields for location information for the first source operand are to identify a vector register.

3. The apparatus of claim 1, wherein the one or more fields for location information for the first source operand to provide memory location information.

4. The apparatus of claim 1, wherein each of the floating-point values of the first source operand is to have a type that is one of a 4-bit floating point value, an 8-bit floating point value, a 16-bit floating point value, a 32-bit floating point value, or a 64-bit floating point value.

5. The apparatus of claim 4, wherein the type is identified by the opcode.

6. The apparatus of claim 1, wherein the instance of the single instruction further comprises one or more fields to provide location information for a second source operand.

7. The apparatus of claim 1, wherein the instance of the single instruction is to indicate a rounding mode to be applied.

8. A method comprising:
translating an instance of a single instruction from a first instruction set architecture to one or more instructions of second instruction set architecture, wherein the instance of the single instruction includes at least one or more fields for an opcode and one or more fields for location information for at least a first source operand and a destination operand, wherein the opcode is to indicate execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows;
decoding the one or more instructions of the second instruction set architecture; and
executing the decoded one or more instructions of the second instruction set to perform operations in accordance with the opcode of the instance of the single instruction from a first instruction set.

9. The method of claim 8, wherein the one or more fields for location information for the first source operand are to identify a vector register.

10. The method of claim 8, wherein the one or more fields for location information for the first source operand to provide memory location information.

11. The method of claim 8, wherein each of the floating-point values of the first source operand is to have a type that is one of a 4-bit floating point value, an 8-bit floating point value, a 16-bit floating point value, a 32-bit floating point value, or a 64-bit floating point value.

12. The method of claim 11, wherein the type is identified by the opcode.

13. The method of claim 8, wherein the instance of the single instruction further comprises one or more fields to provide location information for a second source operand.

14. The method of claim 8, wherein the instance of the single instruction is to indicate a rounding mode to be applied.

15. A system comprising:
memory to store at least an instance of a single instruction;
decoder circuitry to decode the instance of the single instruction, the instance of the single instruction to include at least one or more fields for an opcode and one or more fields for location information for at least a first source operand and a destination operand, wherein the opcode is to indicate execution circuitry is to convert, using truncation or saturation, each floating-point data element of at least the first source operand to an integer value and store the integer value into a corresponding data element position of the destination operand, wherein truncation is to be used when a conversion is inexact and saturation is to be used when a conversion overflows, wherein the decoder circuitry is to support instructions other than the single instruction; and
the execution circuitry to execute the decoded instance of the single instruction according to the opcode.

16. The system of claim 15, wherein the one or more fields for location information for the first source operand are to identify a vector register.

17. The system of claim 15, wherein the one or more fields for location information for the first source operand to provide memory location information.

18. The system of claim 15, wherein each of the floating-point values of the first source operand is to have a type that is one of a 4-bit floating point value, an 8-bit floating point value, a 16-bit floating point value, a 32-bit floating point value, or a 64-bit floating point value.

19. The system of claim 18, wherein the type is identified by the opcode.

20. The system of claim 15, wherein the instance of the single instruction further comprises one or more fields to provide location information for a second source operand.
